(19) United States
(12) Patent Application Publication
(10) Pub. No.: US 2008/0290779 A1
(43) Pub. Date: Nov. 27, 2008

(54) FLUORESCENT LAMP

(76) Inventor: Chun-Chi HSU, Taichung City (TW)

Correspondence Address: FOLEY AND LARDNER LLP;SUITE 500, 3000 K STREET NW, WASHINGTON, DC, 20007, US

(21) Appl. No.: 11/772,312

(22) Filed: Jul. 2, 2007

(30) Foreign Application Priority Data
May 22, 2007 (TW) 096118145

(51) Int. Cl. H01J 63/04

(52) U.S. Cl. 313/486

(57) ABSTRACT

A fluorescent lamp includes: a UV light-generating unit including a lamp seat, a lamp vessel sealed hermetically to the lamp seat, and a luminous gas contained sealingly in the lamp vessel for generating UV light when excited; and an outer vessel mounted detachably on the lamp seat, enclosing the lamp vessel, and having an inner surface coated with a UV-converting material.

### BACKGROUND OF THE INVENTION

1. Field of the Invention

The invention relates to a fluorescent lamp, more particularly to a fluorescent lamp including a lamp vessel containing a luminous gas therein and an outer vessel enclosing the lamp vessel and coated with a phosphor material.

2. Description of the Related Art

U.S. Pat. No. 7,088,056 discloses a fluorescent lamp that includes a case, a base connected to the case, and a luminous bulb mounted sealingly on the case. The luminous bulb includes an inner tube that encloses an induction coil therein, and an outer tube sealed from the inner tube, containing a mercury-containing luminous gas therein, and coated with a phosphor layer on an inner surface thereof. The case, the base, the induction coil, and the luminous bulb are integrated into one unit. As such, when the phosphor layer deteriorates, the entire unit is required to be replaced.

### SUMMARY OF THE INVENTION

Therefore, the object of the present invention is to provide a fluorescent lamp that can overcome the aforesaid drawback associated with the prior art.

Accordingly, a fluorescent lamp of the present invention comprises: a UV light-generating unit including a lamp seat, a lamp vessel sealed hermetically to the lamp seat, and a luminous gas contained sealingly in the lamp vessel for generating UV light when excited; and an outer vessel mounted detachably on the lamp seat, enclosing the lamp vessel, and having an inner surface coated with a UV-converting material.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of a fluorescent lamp according to the present invention;

FIG. 2 is an assembled partly sectional view of the first preferred embodiment;

FIG. 3 is an assembled partly sectional view of the second preferred embodiment of a fluorescent lamp according to the present invention; and

FIG. 4 is an assembled partly sectional view of the third preferred embodiment of a fluorescent lamp according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

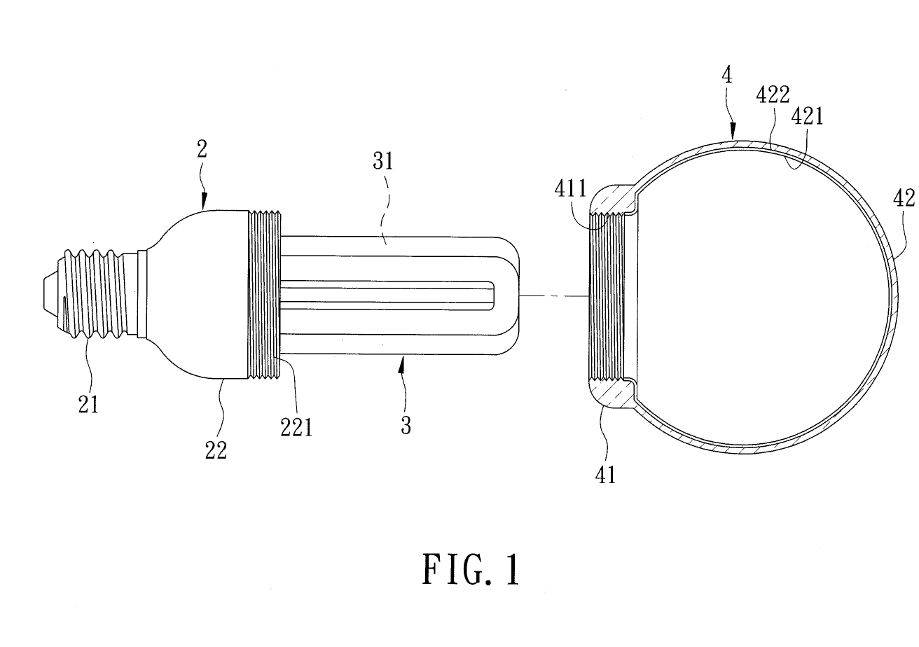

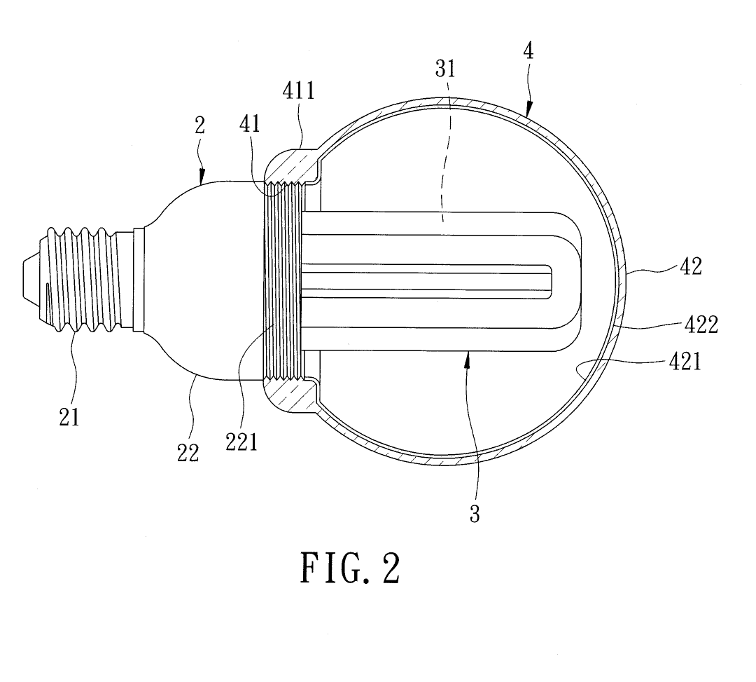

Referring to FIGS. 1 and 2, the first preferred embodiment of a fluorescent lamp according to the present invention is shown to include: a UV light-generating unit including a lamp seat 2, a lamp vessel 3 sealed hermetically to the lamp seat 2 and defining a chamber 31 therein, and a luminous gas contained sealingly in the chamber 31 in the lamp vessel 3 for generating UV light when excited; and an outer vessel 4 mounted detachably on the lamp seat 2, enclosing the lamp vessel 3, and having an inner surface 422 coated with a UV-converting material 421.

In this embodiment, the lamp seat 2 has a conductive base 21 and a case 22 opposite to the conductive base 21. The outer vessel 4 has a connecting end portion 41 connected detachably to the case 22 of the lamp seat 2, and a bulb portion 42 extending from the connecting end portion 41 of the outer vessel 4. The UV-converting material 421 is coated on the inner surface 422 of the bulb portion 42 of the outer vessel 4.

The case 22 of the lamp seat 2 has an outer threaded section 221. The connecting end portion 41 of the outer vessel 4 has an inner threaded section 411 that engages threadedly the outer threaded section 221 of the case 22.

The luminous gas includes a mercury-containing inert gas, such as Ar and Ne. The UV-converting material 421 is a phosphor material.

In use, the luminous gas in the chamber 31 in the lamp vessel 3 is excited to radiate UV light. The generated UV light passes through the lamp vessel 3 and into the outer vessel 4, and is converted into visible light through the UV-converting material 421.

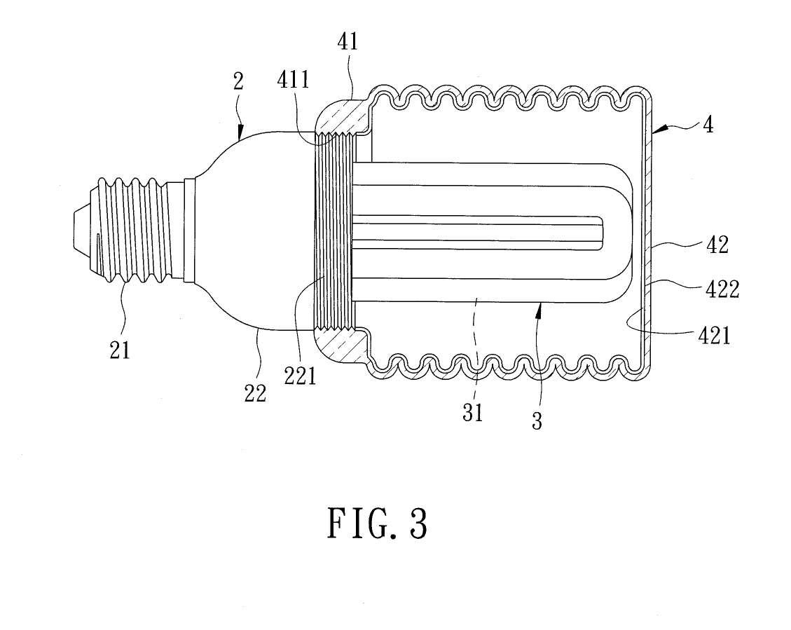

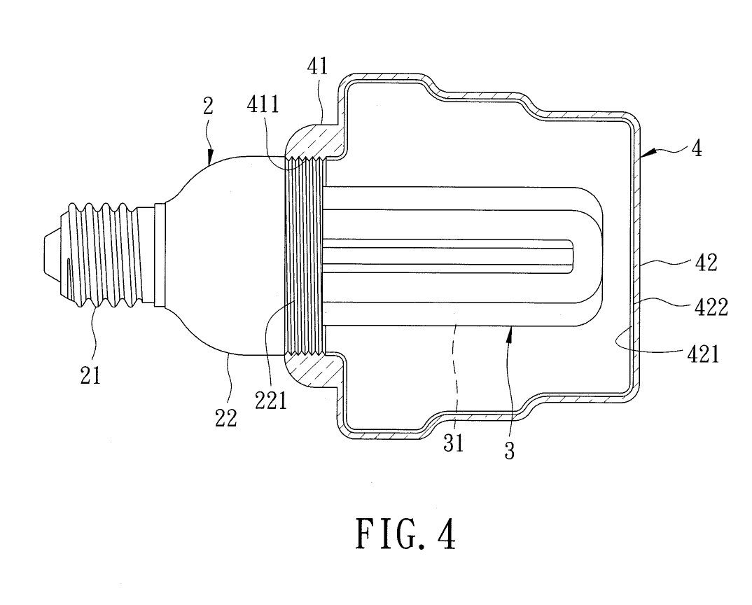

Referring to FIGS. 3 and 4, the second and third preferred embodiments of the present invention differ from the previous preferred embodiment in that the outer vessels 4 of the second and third preferred embodiments have a different shape which is chosen based on actual requirements.

When the UV-converting material 421 deteriorates, only the outer vessel 4 is required to be replaced. Hence, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fluorescent lamp comprising:
a UV light-generating unit including
a lamp seat,
a lamp vessel sealed hermetically to said lamp seat, and
a luminous gas contained sealingly in said lamp vessel for generating UV light when excited; and
an outer vessel mounted detachably on said lamp seat, enclosing said lamp vessel, and having an inner surface coated with a UV-converting material.

2. The fluorescent lamp as claimed in claim 1, wherein said lamp seat has a conductive base and a case opposite to said conductive base, said outer vessel having a connecting end portion connected detachably to said case of said lamp seat, and a bulb portion extending from said connecting end portion of said outer vessel, said UV-converting material being coated on said inner surface of said bulb portion of said outer vessel.

3. The fluorescent lamp as claimed in claim 2, wherein said case of said lamp seat and said connecting end portion of said outer vessel are threadedly engaged.

4. The fluorescent lamp as claimed in claim 1, wherein said luminous gas includes a mercury-containing inert gas.

5. The fluorescent lamp as claimed in claim 1, wherein said UV-converting material is a phosphor material.
